(19) United States
(12) Patent Application Publication
(10) Pub. No.: US 2008/0191499 A1
(43) Pub. Date: Aug. 14, 2008

(54) Electronic Tongue Strike Mechanism

(76) Inventor: John W. Stein, Allentown, PA (US)

Correspondence Address: BARLEY SNYDER, LLC, 1000 WESTLAKES DRIVE, SUITE 275, BERWYN, PA, 19312, US

(21) Appl. No.: 12/042,943

(22) Filed: Mar. 5, 2008

Related U.S. Application Data
(63) Continuation of application No. 11/222,404, filed on Sep. 8, 2005.
(60) Provisional application No. 60/607,619, filed on Sep. 8, 2004.

(51) Int. Cl. E05B 15/02

(52) U.S. Cl. 292/341.16; 292/341.15

(57) ABSTRACT

A mechanism which can be mounted in a door frame is disclosed. The mechanism has a main mounting bracket which is mountable to a door frame, a tension plate which is pivotally mounted to the main mounting bracket a tongue strike mounted on the tension plate for engaging a door bolt and a pressure sensor mounted on the tension plate to sense relative movement between the tension plate and the main mounting bracket caused by the door bolt being urged against the tongue strike. The pressure sensor feeds electronics which operate to control release of the tongue strike.

### CROSS-REFERENCE TO RELATED APPLICATION DATA

This application claims the benefit of the earlier filed U.S. patent application Ser. No. 11/222,404 that has a filing date of Sep. 8, 2005 and that claims the benefit of the earlier filed U.S. Provisional Patent Application No. 60/607,619 that has a filing date of Sep. 8, 2004.

### FIELD OF THE INVENTION

The invention relates generally to the field of door securing mechanisms and more particularly to an electronic strike mechanism.

### BACKGROUND

Numerous latching mechanisms have been developed for retaining and/or opening doors. Some of these mechanisms consist of a matched set of hardware for mounting both on the door and the door frame such that the latching device is actuated by an electric solenoid which retracts a latching mechanism on the frame or actuates a mechanism that releases a latching member from engagement with its mating structure mounted on the door. The solenoid may be activated from a remote location to release or lock the door allowing control over door locking and releasing. These mechanisms are typically designed with the door and doorframe and sold as an assembly.

An electric strike assembly is shown in U.S. Pat. No. 5,076,625 in which a door mechanism having a deadlocking-type latch is disclosed. The latch consists of a forked tongue mounted on a pivot shaft so that it may pivot about the axis of the shaft only when released by movement of a rod. The rod in turn is actuated by a manual release bar or by a keeper to rotate slightly counter-clockwise bringing the outer edge of the nub horizontally and thereby release the forked tongue. A spring biases the tongue so that the keeper is returned to its last position only when the door is closed, striking the stop, and rotating the tongue against the force of the biasing spring. The strike is adapted to provide an electric release for doors equipped with a companion forked tongue mechanism.

Another electrically operated securing plate for door locks, mounted inside a door frame, is shown in U.S. Pat. No. 5,195,792. That patent teaches a mechanism having a securing plate and a ratchet means cooperating with the securing plate to retain the securing plate in a locked position. The securing plate pivots about the spindle and is arranged to be moved between an open and closed position by the bolt and to remain in one or the other of these positions. A cam and pin also act as an indicator designed to cooperate with the securing plate in sensing the position of the bolt in relation to a limit breaker or the like when the securing plate is in a closed position. The securing plate is so arranged that by pressing against a side wall of the plate recess during a closing movement, the bolt will force the securing plate from the open door position to the closed door position. It is also arranged so that by pressing against a side wall of the plate recess during an opening movement, the bolt will force the securing plate from the closed door position to the open door position.

While these mechanisms and others within the state-of-the-art provide a securely locked door, they generally require activation of a high voltage high current solenoid by an electric signal to release the door lock. The strike plates and latching mechanisms are specifically designed to bind or otherwise lock when the door is urged and the latching mechanism is in a locked position. In many circumstances, if the door is urged at the same time that the electrical signal is sent to the solenoid for release, binding occurs against the latching mechanism thus preventing it from releasing. Also, the electrical signal that activates the solenoid generally comes from key entry, card swipe or manual handheld button actuating devices thus requiring several actions to open the door. Additionally prior art indicates that present electric strike mechanisms are mounted inside the door frame using high current high voltage solenoids eliminating marketing to the average homeowner handyman. What is needed is a simple door opening mechanism that may be operated in an automated fashion such that binding of the latching mechanism during release is prevented.

### SUMMARY

In view of the forgoing, the invention provides a mechanism which can be mounted external to a door frame with little door frame modification or door bolt cavity invasion. The mechanism consists of a main mounting bracket which is fastened to the door frame, a tension plate which is pivotally mounted to the main mounting bracket, a tongue strike mounted on the tension plate for engaging a door bolt and a pressure sensor mounted on the tension plate to sense relative movement between the tension plate and the main mounting bracket caused by the door bolt being urged against the tongue strike.

### BRIEF DESCRIPTION OF THE DRAWINGS

The invention will now be described by way of example with reference to the accompanying figures of which:

FIG. 1A is a perspective view showing a typical strike plate mounted in a doorframe;

FIG. 1B is a perspective view showing doorframe modifications;

FIG. 1C is a perspective view of the tongue strike mechanism having a cover removed according to the present invention;

FIG. 1D is a perspective view of the tongue strike mechanism of FIG. 1C having the cover applied;

FIG. 2A is a sectional top-down view of the tongue strike mechanism of FIG. 1C shown in the locked position;

FIG. 2B is a sectional top-down view similar to that of FIG. 2A wherein the tongue strike mechanism is shown in the un-locked position;

FIG. 2C is a sectional top-down view similar to that of FIG. 2A wherein the door is shown in an open position;

FIG. 2D is a perspective view showing the tongue strike of FIG. 1C from the wall side;

FIG. 3 is an exploded perspective view of the tongue strike mechanism of FIG. 1C;

FIG. 4 is a flowchart describing an algorithm for operation of the tongue strike mechanism;

FIG. 5 is a block diagram supporting flowchart, FIG. 4 showing an overview of electronics for operating the tongue strike mechanism; and

FIG. 6 is a block diagram of a solenoid driver according to the invention.

### DETAILED DESCRIPTION OF THE EMBODIMENTS

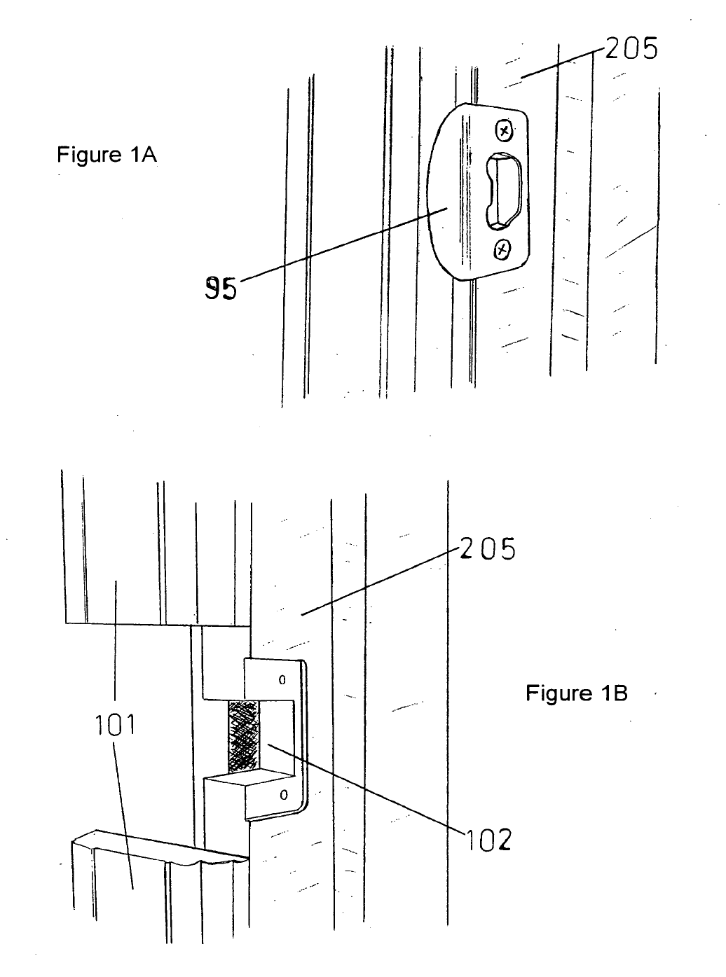

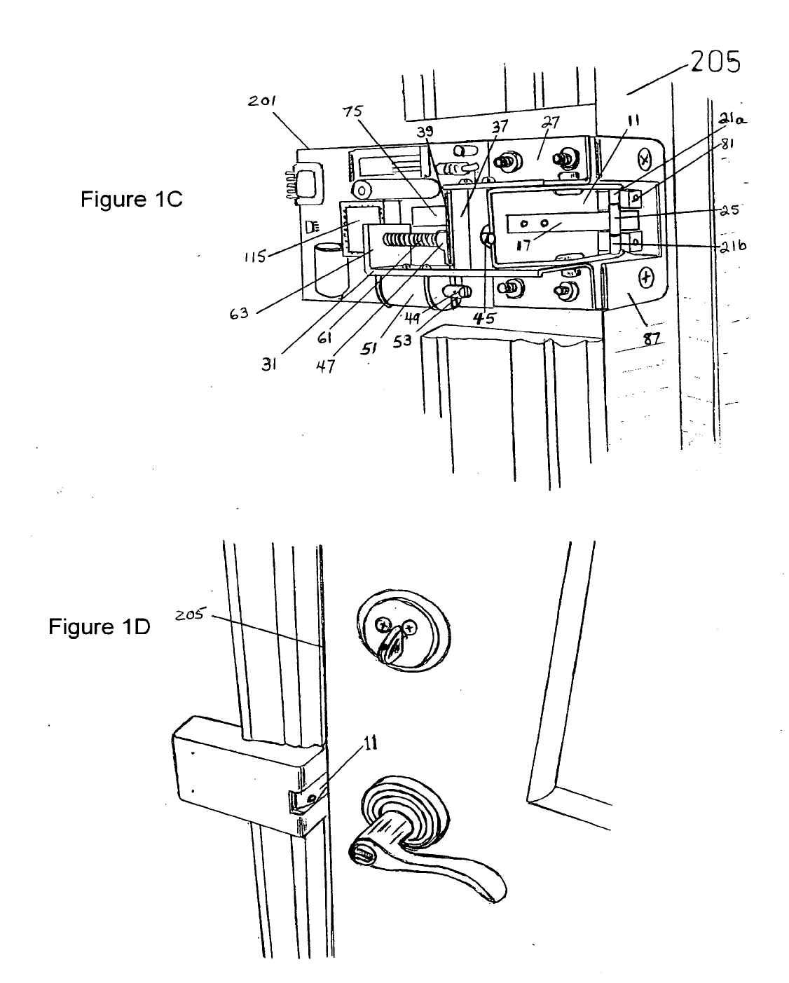

The invention will now be described in greater detail first with reference to FIGS. 1A-D which show views of an exemplary embodiment of the invention. FIG. 1A shows a typical door strike 95 mounted on a doorframe 205. As shown in FIG. 1B, the door strike 95 has been removed from the doorframe 205 and the door trim 101 has been cut to form an enlarged cavity 102 a shown in FIG. 1C. The electronic tongue strike mechanism 201 is installed within the enlarged cavity 102.

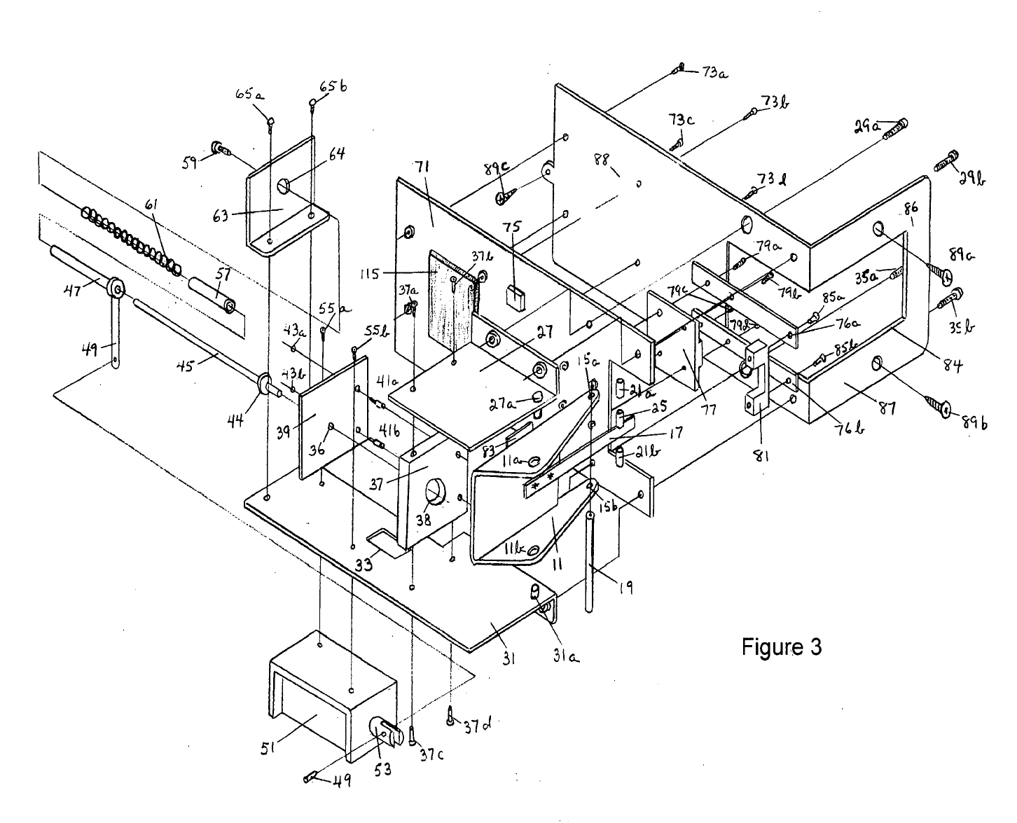

Each of the major components of the electronic tongue strike mechanism 201 will now be described in greater detail. A mounting bracket 87 supports the assembly within the enlarged cavity 102 and also supports the major components as will now be described in greater detail. A tension plate electronics board 71 is attached to the mounting bracket 87 with suitable fasteners 73a,b,c,d. (see FIG. 3). While these and other fasteners that will later be described are shown as screws, it should be understood by those reasonably skilled in the art that other suitable fasteners may be substituted for the screws. The tension plate electronics board 71 is formed of an insulated material such as a PC board and supports the electronics 115 which will which will be described below. A door pressure sensor 75 is mounted on the tension plate electronics board 71 and passes through an opening there in toward the main mounting bracket 87. An upper tongue strike support bracket 27 and a lower tongue strike support bracket 31 are supported on the tension plate electronics board 71 by suitable fasteners 29a,b and 35a,b. The tongue strike 11 is formed from a plate to have a pair of generally triangular extensions bent from a main portion. It should be understood by those reasonably skilled in the art that the main portion and the triangular extensions bent therefrom may take other shapes. A pair of main bearings 11a,b and a pair of tongue strike roller shaft holes 15a,b are formed in the triangular extensions. The tongue strike 11 is rotatably mounted to the upper and lower tongue strike support brackets 27, 31 on an upper main bearing shaft 27a and a lower main bearing shaft 31a which are each inserted into main bearings 11a,b. A bias spring 17 is mounted on the inside of the tongue strike 11 and extends outwardly toward the tongue strike roller shaft holes 15a,b. Mounted within the strike roller shaft holes 15a,b is a strike roller shaft 19 which supports a pair of strike rollers 21a,b and of a smaller outside diameter strike roller spacer 25 positioned between the strike rollers 21a,b.

Behind the tongue strike 11, the upper and lower tongue strike support brackets 27, 31, also support a tongue strike backstop 37 using tongue strike backstop fasteners 37a,b,c, and d. The tongue strike backstop 37 is generally rectangular in profile with a clearance opening 38. A latch support hinge 39, generally rectangular in profile with hole 36 therein, is supported by the tongue strike backstop 37 hinge bearing pins 41a,b and retained by hinge retainers 43a,b. The tongue strike latch 45 is supported by opening 36 on the latch end and on the opposite end by the latch bearing plate 63 bearing hole 64. Latch bearing plate 63 may optionally be formed integral with the lower tongue strike support bracket 31. The latch bearing plate 63 is presently shown attached with latch bearing plate fasteners 65a,b. The tongue strike latch 45 is generally cylindrical and has a shoulder 44 formed near a front end thereof. The tongue strike latch 45 supports a tie link 47 having a pin 49 extending there from and also supports an anvil 57 and a latch return spring 61. The tie link 47, anvil 57, and latch return spring 61 are supported on the tongue strike latch 45 between the latch bearing plate hole 64 and the latch support hinge hole 36 to form a hammer/anvil assembly.

A solenoid 51 is mounted on the undersigned of the lower tongue support bracket 31 by suitable fasteners 55a,b. A solenoid armature 53 extends forward out of the solenoid 51 for receiving the pin 49 through a solenoid access hole 33 formed in the lower tongue support bracket 31. The solenoid 51 is configured to be powered by a battery so that the tongue strike mechanism 201 may be installed onto an existing door frame without the need to run wires for power to the mechanism.

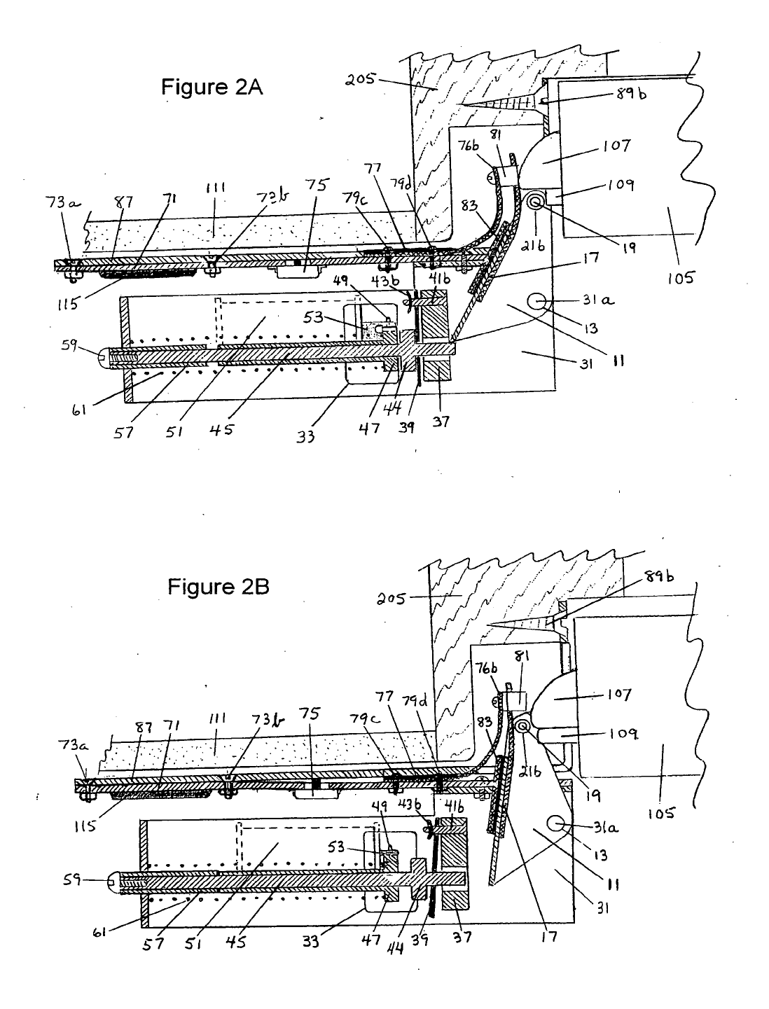

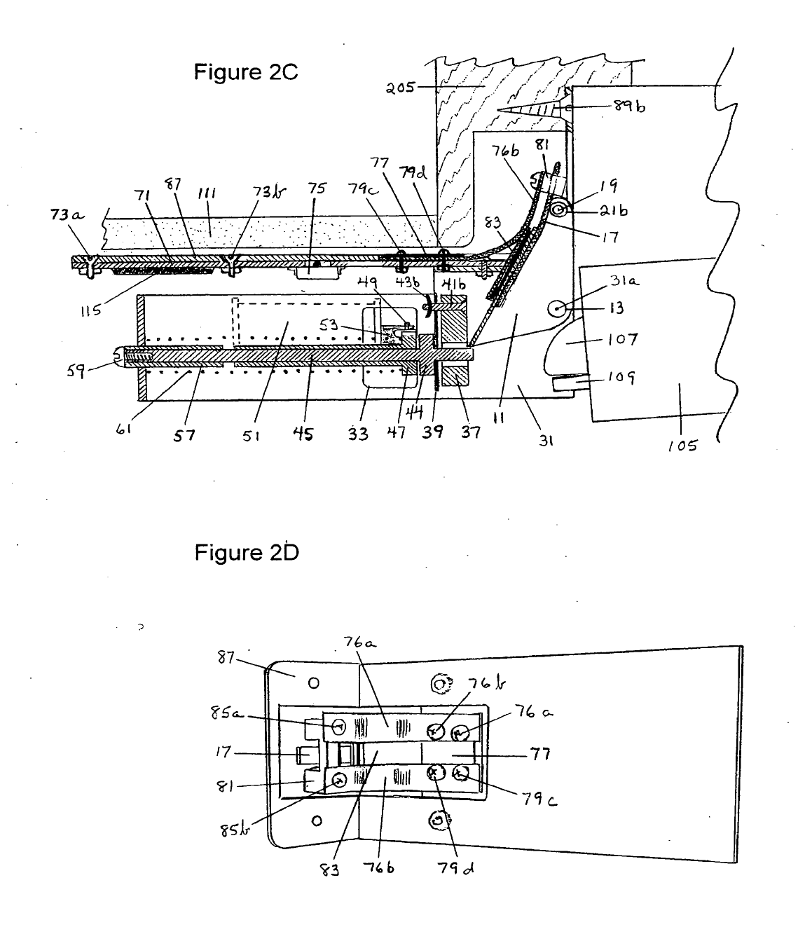

Turning now to FIGS. 2D and 3, the main mounting bracket 87 and components mounted between it and the tension plate electronics board 71 will be described in greater detail. The main mounting bracket 87 has a generally planar major portion 88 and a generally planer minor portion 86 bent therefrom and mounted to the door frame by main mounting fasteners 89a,b,c. An opening 84 is formed between the major and minor portions 88, 86. Control electronics 115 are mounted on the tension plate electronics board 71. A pair of door status contact springs 76a,b are mounted on housing 77 located in the vicinity of the opening 84 to PC board 71 using screws 79a,b,c and d. A door status spring guide 81 is attached to the distal ends of each door status contact springs 76a,b located within the opening 84. The tension plate electronics board 71 is mounted to the main mounting bracket 87 by a plurality of suitable board fasteners 73a,b,c,d which are located along the major portion 88 at a location which is spaced apart from the opening 84 such that the tension plate electronics board 71 is mounted in a cantilever fashion having a free end near the opening 84. In this arrangement, the tension plate electronics board 71 serves a dual function in that it hosts the electronics 115 needed to control the electronic tongue strike mechanism 201 and some of the mechanical components while it also serves as a tension plate to which the rest of the mechanism is attached that works integral with the door pressure sensor 75 to sense pressure being applied to the door. Two nylon screws 29b and 35b limit tension plate electronics board 71 movement by being adjusted to make contact with the opposing side of the main mounting bracket 87 allowing enough movement of the tension plate electronics board 71 to activate the door pressure sensor 75 when pressure is applied to the door. Adjustment of the screws may be maintained by lock nuts or Nylock inserts pressed into the upper and lower tongue strike support brackets 27 and 31.

Referring again to FIG. 3 and FIGS. 2A, 2B, it can be seen that the tongue strike 11 is biased and limited in movement by the tongue strike backstop 37 and the door status contact springs 76a,b. The bearing geometry is designed such that pressure applied to the door pushes the tongue strike 11 against the tongue strike latch 45 and away from the tongue strike backstop 37.

Unlatching of the tongue strike 11 is accomplished by retracting the tongue strike latch 45 using the solenoid 51 to operate the tie link 47 which actuates the tongue strike latch 45. This is done indirectly through a hammer/anvil assembly described above. The tongue strike latch 45 is supported on the tongue strike 11 end by the latch support hinge hole 36 and on the opposite end by the latch bearing plate hole 64. The latch support hinge 39 therefore provides near zero bearing friction support for the tongue strike latch 45 and is itself supported by hinge bearing pins 41a,b pressed into the tongue strike backstop 37. The latch support hinge 39 is retained on the hinge bearing pins 41a,b by hinge retainers 43a,b. This arrangement facilitates the use of a relatively low power source such as battery power for operating the mechanism.

An electrical assembly consisting of a door status contact spring housing 77, door status contact springs 76a,b and door status contact spring guide 81 provides for door status signals to the control electronics 115 which will be described in greater detail below. The door status contact spring housing 77 and the door status contact springs 76a,b are electrically connected to the tension plate electronics board 71 by door status contact spring fasteners 79a,b,c,d. The door status contact spring guide 81 is attached to the other end of door status contact springs 76a,b by door status contact spring guide fasteners 85a,b. A door status spring commutator 83 is mounted on the back of the tongue strike 11 and is electrically isolated therefrom by an insulative layer. This assembly in combination with the door status contact spring commutator 83 provides a method of communicating the open/closed status of the door to the control electronics 115.

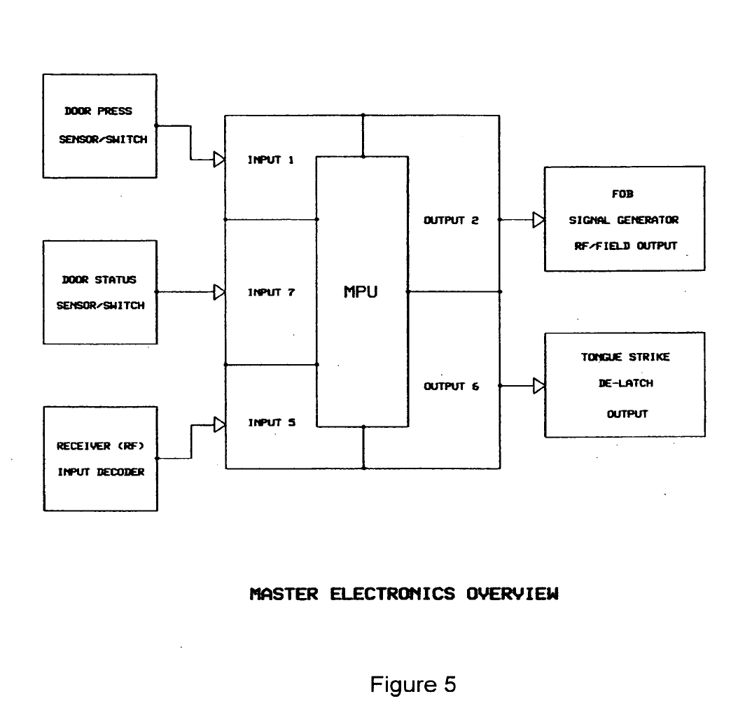

Referring now to FIG. 5, the control electronics 115 will be described in greater detail with reference to this block diagram which shows an exemplary implementation for the control electronics 115. A microprocessor unit (MPU) or like control unit, receives input signals from the door pressure sensor 75 at input 1, the door status contact springs 76a,b at input 7 and a radiofrequency decoded signal at input 5 coming from a buttonless fob or other remote control actuation device. The MPU operates on these inputs to generate an output to the fob signal generator at output 2 and an output for driving the solenoid 51 at output 6.

Operation of the electronic tongue strike mechanism 201 will now be described in greater detail. In the door locked position shown in FIG. 2A, the tongue strike latch 45 is held extended by the latch return spring 61 pressing between bearing plate 63 and latch shoulder 44. In the latch extended position, the tongue strike 11 is blocked from pivoting. With no pressure applied to the door 105, the tension plate electronics board 71 lies flat against the main mounting bracket 87 causing the door pressure sensor 75 actuator to be depressed which indicates no pressure is being applied the door 105. The large door bolt 107 in this instance is directly deflecting the bias spring 17 and indirectly deflecting the door status contact springs 76a,b through the door status contact spring guide 81. The deflection of door status contact springs 76a,b breaks electrical contact with the door status contact spring commutator 83 indicating to the control electronics 115, the door is closed.

Fasteners 29a and 35a pass through and clear enlarged holes in the main mounting bracket 87 attaching the entire tongue strike assembly to tension plate electronics board 71 thereby electrically isolating the assembly so that an oscillating field can be induced by the control electronics 115 into the assembly which makes electrical contact with bolts 107 and 109 causing this oscillating field to be imparted to the door lock assembly and ultimately to the person touching the door knob while the door is closed. A remote control device such as a keyless button-less fob device on the person is sensitive to the field generated around the person touching the door knob. The remote control device will, upon sensing the field, send a coded signal to the transceiver on the control electronics 115 which will operate the solenoid 51 if the code is correct.

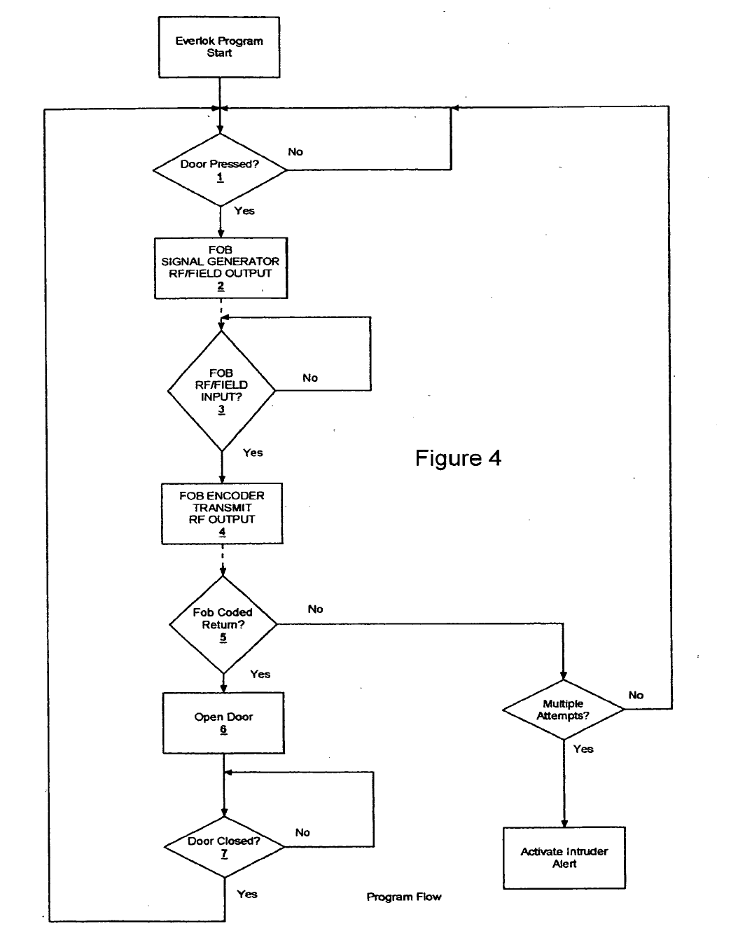

An algorithm for controlling the solenoid with the remote control device is described in FIG. 4. After program start, the control electronics 115 checks if the door is pressed at step 1. If so, a radiofrequency field is output from its signal generator at step 2. A remote-control device or buttonless fob senses the radiofrequency field at step 3 and transmits a unique identification code back to the control electronics 115 at step 4. If the control electronics 115 receives the correct unique identification code from the remote-control device at step 5 then it sends a signal to solenoid 51 to open the door 105 at step 6. Once the control electronics 115 senses that the door is closed at step 7, the process returns to Step 1, to check if door pressed. In the event that multiple door press attempts result in incorrect codes or no return signals to the control electronics 115 at step five, the control electronics 115 may optionally activate an intruder alert system which may optionally be tied to an alarm or other indicator for recording an attempted intrusion.

In the door pressed and locked position shown in FIG. 2A, pressing the door 105 translates pressure to the large door bolt 107 which in turn imparts pressure to the tongue strike 11 causing the tension plate electronics board 71 to flex away from the main mounting bracket 87. The door pressure sensor 75 attached to the tension plate electronics board 71 senses this flexing and sends a signal to the control electronics 115 causing an oscillating signal to be sent to the electrically isolated tongue strike assembly as described above. If the buttonless fob returns a valid signal to the transceiver on the control electronics 115 then a pulse from the solenoid driver on the control electronics 115 causes the solenoid 51 to pull in the solenoid armature 53. The solenoid armature is attached to the hammer solenoid tie link 47 by the hammer solenoid tie pin 49. The gap lying between the hammer/solenoid tie link 47 and the anvil 57 allows the hammer solenoid tie pin 47/49 to accelerate un-opposed until it makes contact with the anvil 57. The energy stored in the hammer solenoid tie link 47/49 during acceleration is imparted to the anvil 57 which imparts it's accelerated energy to the anvil retainer FIG. 59 attached to the hammer/solenoid tie pin 47/49. This hammer anvil concept assists the tongue strike latch 45 to release the tongue strike 11 under relatively low power such as that provided by a battery.

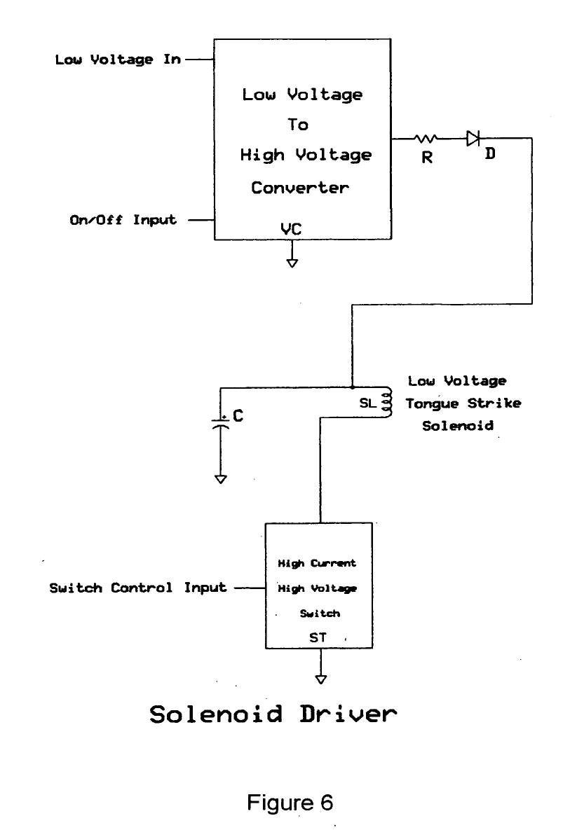

Reference will now be made to FIG. 6 showing a block diagram of a solenoid driver circuit according to an embodiment of the invention. Assume that low voltage (battery) is always applied to the converter VC input. A on pulse from a control device such as the MPU is applied to the On/Off input of the voltage converter VC with enough duration to charge up the capacitor C with a high voltage. Resistor R is a current limit resistor that limits the amount of current to safe levels during charge up to protect the Voltage Converter VC. The diode D blocks voltage from bleeding back into the Voltage Converter VC when the Voltage Converter VC is turned off. Once charged up, the capacitor will hold a charge for many hours depending on the components used.

Once the capacitor C is charged, it generally holds it's charge until a pulse arrives from a control device such as the MPU. When the pulse arrives, a large surge voltage/current is placed across the low voltage solenoid SL causing the solenoid SL to briefly be overdriven resulting in brief excessive force being applied to the solenoid armature 53.

This brief excessive force is translated to the hammer of the hammer/anvil system. Because there is a gap between the hammer and anvil system this extreme force is free to accelerate with no restriction amplifying the hammer/anvil effect. This synergy between the hammer/anvil and solenoid drive assures the latch 45 will release the tongue strike 11. Additionally this electronic scheme allows a larger selection of battery types due to the indirect operation of the solenoid by the capacitor rather than direct solenoid operation by the battery.

Once unlatched (see FIG. 2B) the tongue strike 11 is pushed away from the large door bolt by three forces. First, the geometry of the tongue strike main bearings 31a,b and the tongue strike roller shaft 19 is controlled by the location of tongue strike backstop 37 such that pressure applied to the door causes the tongue strike 11 to move away from the tongue strike backstop 37. The more force applied to the door 105 the more the tongue strike 11 is urged to swing to the open position. Secondly, the large bolt 107 has been imparting it's spring energy to the bias spring 17 which further encourages the tongue strike 11 to move to the open position. Lastly the spring energy stored in the small door bolt 109 is imparted to the tongue strike 11 via contact with strike roller spacer 25. It should be understood by those skilled in the art that the small door bolt 109 is not present on all doors. Its use here to import spring energy on the tongue strike 11 is therefore optional.

FIGS. 2A and B show the door 105 in the closed or partially closed position where door status contact springs 76a,b do not come in contact with the door status contact spring commutator 83. When in contact with the door status contact springs 76a,b, the door status contact spring commutator 83 completes a circuit between the doors status contact springs 76a,b. This indicates to the control electronics 115 that the door 105 is not fully open. FIG. 2C shows the door 105 in the open position causing door status contact springs 76a,b to come in contact with door status contact spring commutator 83 completing a circuit as described above indicating to the control electronics 115 that the door is open.

The embodiment of the electronically based door strike mechanism is advantageously located primarily external to a door frame and uses a tongue strike extending into the door frame to make contact with traditional door bolts. Additionally the door strike mechanism utilizes parts geometry and door bolt spring energy to allow efficient battery operation coupled with electronic and radio technology to affect a keyless/button-less secure home or business entry system. Advantageously provided herein is the opportunity to offer a door entry system for installation by the average handy consumer. Additionally the electronic tongue strike mechanism offers efficient door release capability such that battery operation can be used.

The pressure sensor advantageously feeds electronics which through radio means operates to securely release the tongue strike through button-less key fob devices.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A mechanism for selectively securing a hinged door having an outwardly biased bolt extending from the door, the mechanism comprising:
a tongue strike rotatable about a tongue strike axis of rotation, the tongue strike being rotationally biased about the tongue strike axis of rotation toward an open position by the bolt while the door is secured by the mechanism.

2. The mechanism according to claim 1, further comprising:
a bias spring connected to the tongue strike, the bias spring being biased by the bolt while the door is secured by the mechanism and the bias spring causing the tongue strike to be rotationally biased about the tongue strike axis of rotation toward an open position while the door is secured by the mechanism.

3. The mechanism according to claim 1, wherein the tongue strike axis of rotation is substantially parallel to an axis of rotation of the door.

4. The mechanism according to claim 1, further comprising:
a tongue strike main bearing carried by the tongue strike, the tongue strike main bearing preventing opening of the door when the door is secured by the mechanism.

5. The mechanism according to claim 1, further comprising:
a tongue strike latch that selectively obstructs rotation of the tongue strike in the direction in which the tongue strike is biased by the by the bolt while the door is secured by the mechanism.

6. The mechanism according to claim 1, further comprising:
a door status contact spring that rotationally biases the tongue strike about the tongue strike axis of rotation in opposition to the rotational bias of the tongue strike caused by the bolt when the door is secured by the mechanism.

7. A mechanism for selectively securing a hinged door, the door being movable in an opening direction of rotation from a closed position, the mechanism comprising:
a tongue strike rotatable about a tongue strike axis of rotation, the tongue strike selectively obstructing movement of the door in the opening direction of rotation from the closed position;
wherein the tongue strike allows movement of the door in the opening direction of rotation from the closed position in response to pressure being applied to the door in a manner that urges the door to move in the opening direction of rotation.

8. The mechanism according to claim 7, wherein preventing rotation of the tongue strike about the tongue strike axis of rotation obstructs movement of the door in the opening direction of rotation from the closed position.

9. The mechanism according to claim 8, further comprising:
a tongue strike latch that selectively obstructs rotation of the tongue strike.

10. The mechanism according to claim 9, wherein the tongue strike latch discontinues obstructing rotation of the tongue strike in response to pressure being applied to the door in a manner that urges the door to move in the opening direction of rotation.

11. The mechanism according to claim 7, further comprising:
a sensor that senses the pressure being applied to the door in a manner that urges the door to move in the opening direction of rotation;
wherein upon the sensor sensing the pressure being applied to the door, the tongue strike is caused to allow movement of the door in the opening direction of rotation from the closed position.

12. The mechanism according to claim 11, wherein upon the sensor sensing the pressure being applied to the door, the tongue strike is allowed to rotate about the tongue strike axis of rotation.

13. The mechanism according to claim 12, further comprising:
a tongue strike latch that selectively obstructs rotation of the tongue strike about the tongue strike axis of rotation;
wherein upon the sensor sensing the pressure being applied to the door, the tongue strike latch discontinues obstructing rotation of the tongue strike.

14. The mechanism according to claim 13, further comprising:
a solenoid that selectively actuates the tongue strike latch in response to the sensor sensing the pressure being applied to the door.

15. A mechanism for selectively securing a hinged door having an outwardly biased bolt extending from the door and the door being movable in an opening direction of rotation from a closed position, the mechanism comprising:
a tongue strike rotatable about a tongue strike axis of rotation, the tongue strike selectively obstructing movement of the door in the opening direction of rotation from the closed position; and
control electronics configured to generate an oscillating field.

16. The mechanism according to claim 15, wherein the oscillating field is transmitted from the tongue strike to the bolt.

17. The mechanism according to claim 15, wherein the oscillating field is transmitted from the mechanism to a doorknob of the door.

18. The mechanism according to claim 17, wherein the oscillating field is transmitted from the mechanism to the doorknob through the bolt.

19. The mechanism according to claim 15, further comprising:
a remote device operably associated with the oscillating field that transmits a signal to the control electronics in response to the remote device sensing the oscillating field;
wherein in response to receiving the signal from the remote device, the control electronics causes the tongue strike to discontinue obstructing the door from movement in the opening direction of rotation from the closed position.

20. The mechanism according to claim 19, wherein the oscillating field is transmitted to the remote device through a human body associated with the remote device.
